(19) United States
(12) Patent Application Publication
(10) Pub. No.: US 2011/0176045 A1
(43) Pub. Date: Jul. 21, 2011

(54) COMPLEMENTARY METAL-OXIDE SEMICONDUCTOR IMAGE SENSOR, DATA READOUT METHOD THEREOF, AND ELECTRONIC SYSTEM INCLUDING THE SAME

(75) Inventors: Jung Chak AHN, Yongin-si (KR); Kyung Ho LEE, Suwon-si (KR); Young Hwan PARK, Namyangju-si (KR); Young Chan KIM, Seongnam-si (KR); Dong-Yoon JANG, Hwaseong-si (KR); Shy HAMAMI, Hagalil (IL); Uzi HIZI, Herzliya (IL); Yuri FRIEDMAN, Kiryat Ono (IL)

(73) Assignee: SAMSUNG ELECTRONICS CO., LTD., Suwon-si (KR)

(21) Appl. No.: 13/011,531

(22) Filed: Jan. 21, 2011

(30) Foreign Application Priority Data
Jan. 21, 2010 (KR) 10-2010-0005730

(51) Int. Cl. H04N 5/335

(52) U.S. Cl. 348/308; 348/E05.091

(57) ABSTRACT

A complementary metal-oxide semiconductor (CMOS) image sensor and a pixel data readout method of the same are provided. The CMOS image sensor includes: a first readout line which outputs pixel data from a shared pixel group in an odd row of a column of a pixel array in a Bayer pattern during a horizontal period; and a second readout line which outputs pixel data from a shared pixel group in an even row of the column of the pixel array during the horizontal period, wherein pixel data output to the first and second readout lines during the horizontal period correspond to a basic Bayer pattern and pixels from which pixel data are read out in each column sequentially shifts in a column direction at each horizontal period.

### CROSS-REFERENCE TO RELATED APPLICATION

This application claims priority from Korean Patent Application No. 10-2010-0005730, filed on Jan. 21, 2010 in the Korean Intellectual Property Office, the disclosure of which is incorporated herein in its entirety by reference.

### BACKGROUND

Apparatuses and methods consistent with exemplary embodiments relate to image sensor technology, and more particularly, to a complementary metal-oxide semiconductor (CMOS) image sensor for realizing a high frame rate and miniaturization by improving a pixel data readout method, a pixel data readout method of the CMOS image sensor, and an electronic system including the same.

Image sensors are devices that convert external optical image signals into electrical image signals. Image sensors may be classified as CMOS image sensors using CMOS technology and charge coupled device (CCD) image sensors using CCD technology, which are all manufactured using semiconductor technology.

In particular, CMOS image sensors are manufactured using CMOS manufacturing technology. In CMOS image sensors, a pixel converts a light signal radiating from a corresponding portion of a subject into electrons using a photodiode, stores the electrons, converts an amount of charge proportional to a number of accumulated electrons into a voltage signal, and outputs the voltage signal. Such CMOS image sensors are widely used in various electronic devices, such as mobile phones, cameras for personal computers (PCs), video cameras, digital cameras, etc.

CMOS image sensors may be more simple to operate than CCD image sensors. In addition, since a signal processing circuit is integrated in a single chip, CMOS image sensors can be made using a system on chip (SoC), so that miniaturization of a module is possible. Furthermore, existing CMOS technologies can be compatibly used, and therefore, CMOS image sensors can be manufactured inexpensively. With these advantages, demand for CMOS image sensors has been increasing.

It is expected that demand on smaller, high-performance CMOS image sensors with a high pixel rate and high frame rate will increase in the CMOS image sensor market. However, it may be difficult to implement the high performance of CMOS image sensors in a short horizontal period.

In a pixel array of a general CMOS image sensor, data of pixels in a single row is read out during one horizontal period. In a stage before signal processing where data read out from pixels of the pixel array is manifested as an image, a memory for temporarily storing the data read out from the pixels is used. This related art pixel data readout method needs to be improved in order to realize compact high-performance CMOS image sensors that may be demanded in the future image sensor market.

### SUMMARY

One or more exemplary embodiments provide a complementary metal-oxide semiconductor (CMOS) image sensor for reading out pixel data from pixels in a plurality of columns during a single horizontal period and outputting a Bayer signal corresponding to readout pixel data corresponding to a basic Bayer pattern during the single horizontal period, a pixel data readout method of the CMOS image sensor, and an electronic system including the same.

According to an aspect of an exemplary embodiment, there is provided a CMOS image sensor including: a first readout line configured to output pixel data from a shared pixel group in an odd row of an i-th column of a pixel array in a Bayer pattern during a horizontal period, where i is 1 or a natural number greater than 1; a second readout line configured to output pixel data from a shared pixel group in an even row of the i-th column of the pixel array during the horizontal period; a third readout line configured to output pixel data from a shared pixel group in the odd row of an (i+1)-th column of the pixel array during the horizontal period; and a fourth readout line configured to output pixel data from a shared pixel group in the even row of the (i+1)-th column of the pixel array during the horizontal period.

The pixel data output through the first through fourth readout lines during the horizontal period may correspond to a basic Bayer pattern and pixels from which pixel data are read out in the i-th and (i+1)-th columns may sequentially shift in a column direction at each horizontal period.

According to an aspect of another exemplary embodiment, there is provided a CMOS image sensor including: a first readout line configured to output pixel data from a shared pixel group in an odd row of each column of a pixel array in a Bayer pattern during each horizontal period; and a second readout line configured to output pixel data from a shared pixel group in an even row of each column of the pixel array during each horizontal period.

The pixel data output to the first and second readout lines during each horizontal period may correspond to a basic Bayer pattern and pixels from which pixel data are read out in each column may sequentially shift in a column direction at each horizontal period.

According to an aspect of another exemplary embodiment, there is provided a CMOS image sensor including: a plurality of first readout lines configured to output pixel data from a plurality of shared pixel groups in an i-th column of a pixel array in a Bayer pattern during a horizontal period, where i is 1 or a natural number greater than 1; and a plurality of second readout lines configured to output pixel data from a plurality of shared pixel groups in an (i+1)-th column of the pixel array during the horizontal period.

The pixel data output through the first readout lines, pixel data output through the second readout lines, and pixel data output through the first and second readout lines during each horizontal period may correspond to at least one basic Bayer pattern and pixels from which pixel data are read out in the i-th and (i+1)-th columns may sequentially shift in a column direction at each horizontal period.

According to aspects of one or more other exemplary embodiments, the above-described CMOS image sensors may be included in an electronic system having a camera function.

According to an aspect of another exemplary embodiment, there is provided a pixel data readout method of a CMOS image sensor including: outputting pixel data from a plurality of shared pixel groups in odd and even rows of an i-th column of a pixel array in a Bayer pattern during a horizontal period, where i is 1 or a natural number greater than 1; and outputting pixel data from a plurality of shared pixel groups in the odd and even rows of an (i+1)-th column of the pixel array during the horizontal period.

The pixel data output through the operations during the horizontal period may correspond to a basic Bayer pattern and pixels from which pixel data are read out in the i-th and (i+1)-th columns may sequentially shift in a column direction at each horizontal period.

According to an aspect of another exemplary embodiment, there is provided a pixel data readout method of a CMOS image sensor including: outputting pixel data from a shared pixel group in an odd row of each column of a pixel array in a Bayer pattern during horizontal period; and outputting pixel data from a shared pixel group in an even row of each column of the pixel array during the horizontal period.

The pixel data output through the operations during the horizontal period may correspond to a basic Bayer pattern and pixels from which pixel data are read out in the i-th and (i+1)-th columns sequentially shift in a column direction at each horizontal period.

According to an aspect of another exemplary embodiment, there is provided a pixel data readout method of a CMOS image sensor including: outputting pixel data from a shared pixel group in an odd row of each column of a pixel array in a Bayer pattern during a horizontal period; and outputting pixel data from a shared pixel group in an even row of each column of the pixel array during the horizontal period.

The pixel data output through the operations during the horizontal period may correspond to a basic Bayer pattern and pixels from which pixel data are read out in each column sequentially shifts in a column direction at each horizontal period.

According to an aspect of another exemplary embodiment, there is provided a pixel data readout method of a CMOS image sensor including: outputting pixel data from a plurality of shared pixel groups in an i-th column of a pixel array in a Bayer pattern during a horizontal period, where i is 1 or a natural number greater than 1; and outputting pixel data from a plurality of shared pixel groups in an (i+1)-th column of the pixel array during the horizontal period.

The pixel data output through the operations during the horizontal period may correspond to at least one basic Bayer pattern and pixels from which pixel data are read out in the i-th and (i+1)-th columns sequentially shift in a column direction at each horizontal period.

According to an aspect of another exemplary embodiment, there is provided a pixel data readout method of a complementary metal-oxide semiconductor (CMOS) image sensor, the method including: outputting pixel data from pixels in a plurality of rows of a pixel array in a unit corresponding to a basic Bayer pattern, during a single horizontal period.

According to aspects of one or more other exemplary embodiment, the methods may be implemented by executing a computer program for performing the methods stored in a computer readable recording medium.

### BRIEF DESCRIPTION OF THE DRAWINGS

The above and/or other aspects will become more apparent by describing in detail exemplary embodiments thereof with reference to the attached drawings in which:

FIG. 1 is a block diagram of a complementary metal-oxide semiconductor (CMOS) image sensor according to an exemplary embodiment;

FIG. 2 is a diagram of a pattern of a pixel array according to an exemplary embodiment;

FIG. 3 is a diagram showing a procedure where data is read out from a pixel array having a 1×2 shared pixel structure according to an exemplary embodiment;

FIG. 4 is a circuit diagram of a 1×2 shared pixel structure according to an exemplary embodiment;

FIG. 5 is a flowchart of a procedure where data is read out from a pixel array having a 1×2 shared pixel structure according to an exemplary embodiment;

FIG. 6 is a diagram showing a procedure where data is read out from a pixel array having a 1×4 shared pixel structure according to an exemplary embodiment;

FIG. 7 is a flowchart of a procedure where data is read out from a pixel array having a 1×4 shared pixel structure according to an exemplary embodiment;

FIG. 8 is a diagram showing a procedure where data is read out from a pixel array having a 2×2 shared pixel structure according to an exemplary embodiment;

FIG. 9 is a flowchart of a procedure where data is read out from a pixel array having a 2×2 shared pixel structure according to an exemplary embodiment; and

FIG. 10 is a block diagram of an electronic system including a CMOS image sensor according to an exemplary embodiment.

### DETAILED DESCRIPTION OF EXEMPLARY EMBODIMENTS

Exemplary embodiments will now be described more fully hereinafter with reference to the accompanying drawings. An exemplary embodiment may, however, be embodied in many different forms and should not be construed as limited to the exemplary embodiments set forth herein. Rather, these exemplary embodiments are provided so that this disclosure will be thorough and complete. In the drawings, the size and relative sizes of layers and regions may be exaggerated for clarity. Like numbers refer to like elements throughout.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein, the term “and/or” includes any and all combinations of one or more of the associated listed items and may be abbreviated as “/”. Moreover, expressions such as “at least one of,” when preceding a list of elements, modify the entire list of elements and do not modify the individual elements of the list.

It will be understood that, although the terms first, second, etc., may be used herein to describe various elements, these elements should not be limited by these terms. These terms are only used to distinguish one element from another. For example, a first signal could be termed a second signal, and, similarly, a second signal could be termed a first signal without departing from the teachings of the disclosure.

The terminology used herein is for the purpose of describing particular exemplary embodiments only and is not intended to be limiting of the inventive concept. As used herein, the singular forms “a,” “an,” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which the exemplary embodiments belong. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

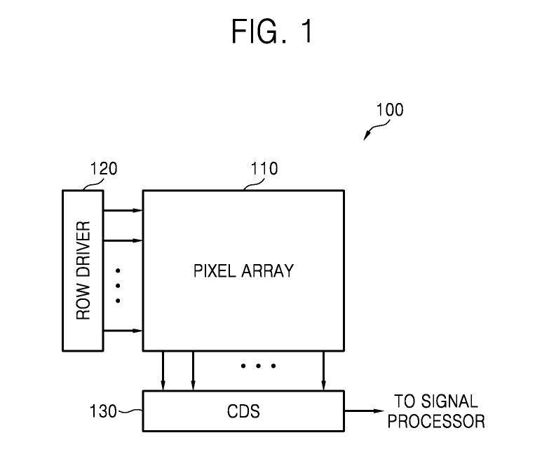

FIG. 1 is a block diagram of a complementary metal-oxide semiconductor (CMOS) image sensor 100 according to an exemplary embodiment. Referring to FIG. 1, the CMOS image sensor 100 includes a pixel array 110, a row driver 120, and a correlated double sampling (CDS) block 130. The CMOS image sensor 100 may also include at least one of elements for generating timing control signals, selecting a pixel in the pixel array 110, outputting pixel data read out from the pixel array 110, and performing signal processing on the output pixel data.

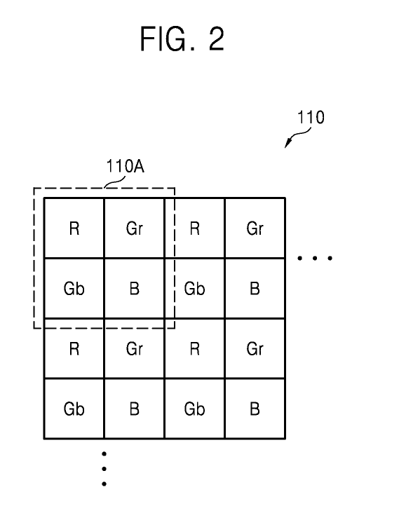

The pixel array 110 may have a Bayer pattern in which a row having a red (R) pixel alternating with a green (G) pixel alternates with a row having a G pixel alternating with a blue (B) pixel, and G pixels are diagonally positioned. FIG. 2 is a diagram of a pattern of a pixel array 110 according to an exemplary embodiment. Referring to FIG. 2, the pixel array 110 includes a plurality of basic Bayer patterns 110A continually arranged. In each basic Bayer pattern 110A, a G pixel closely related with a luminance signal is disposed in every row and an R pixel and a B pixel alternate with each other between rows. Such a Bayer pattern has higher luminance resolution than other pixel patterns.

Referring back to FIG. 1, the CDS block 130 performs CDS on pixel data output from column lines of the pixel array 110 to convert analog pixel data into a digital signal. Digital pixel data output from the CDS block 130 is sent to a signal processor (not shown). The CDS block 130 may be disposed at one side of the pixel array 110, above and/or below the pixel array 110, or on the left and/or right of the pixel array 110.

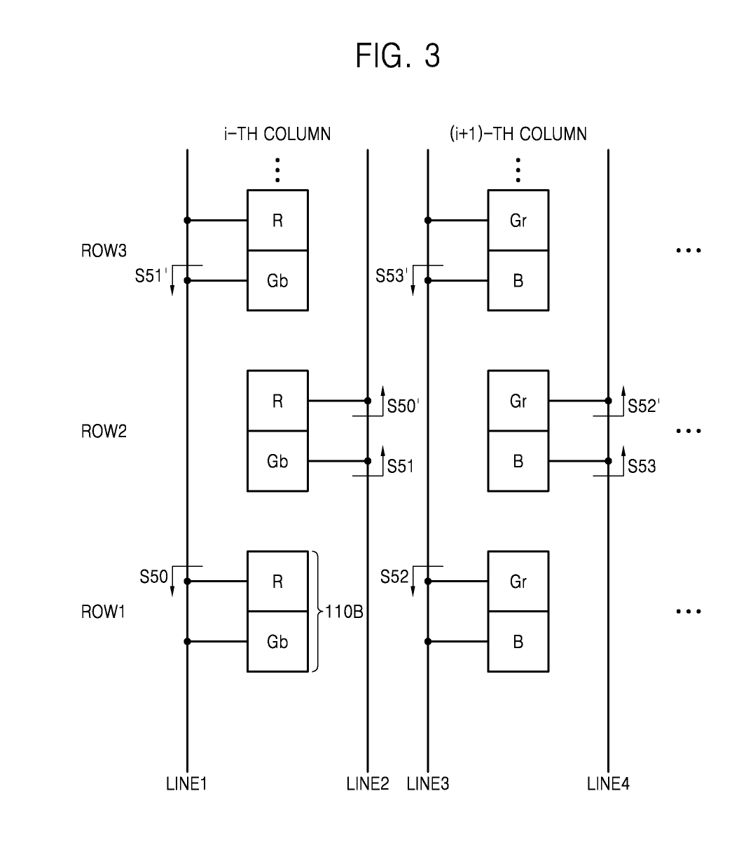

FIG. 3 is a diagram showing a procedure where data is read out from a pixel array 110 having a 1×2 shared pixel structure 110B according to an exemplary embodiment. Referring to FIG. 3, the pixel array 110 includes a plurality of shared pixel groups in an i-th column (where “i” is 1 or a natural number greater than 1), a plurality of shared pixel groups in an (i+1)-th column, and first through fourth readout lines LINE1, LINE2, LINE3, and LINE4.

The first readout line LINE1 outputs pixel data from shared pixel groups in odd rows among the plurality of shared pixel groups in the i-th column of the pixel array 110 during a single horizontal period. The second readout line LINE2 outputs pixel data from shared pixel groups in even rows among the plurality of shared pixel groups in the i-th column of the pixel array 110 during a single horizontal period.

The third readout line LINE3 outputs pixel data from shared pixel groups in odd rows among the plurality of shared pixel groups in the (i+1)-th column of the pixel array 110 during a single horizontal period. The fourth readout line LINE4 outputs pixel data from shared pixel groups in even rows among the plurality of shared pixel groups in the (i+1)-th column of the pixel array 110 during a single horizontal period.

However, to output pixel data in a basic Bayer pattern during a single horizontal period, the CMOS image sensor 100 skips Gb and B pixels in a first sub row of shared pixel groups in a first row ROW1. Rather, the CMOS image sensor 100 respectively outputs to the first and third readout lines LINE1 and LINE3 pixel data of R and Gr pixels in a second sub row of the shared pixel groups in the first row ROW1 in the i-th and (i+1)-th columns during a first horizontal period. Consequently, during the first horizontal period, the pixel data of the R and Gr pixels in the second sub row of the shared pixel groups in the first row ROW1 in the i-th and (i+1)-th columns and pixel data of Gb and R pixels in a first sub row of shared pixel groups in a second row ROW2 in the i-th and (i+1)-th columns are output. In other words, R, Gr, Gb and B pixel data corresponding to the basic Bayer pattern are output from the i-th and (i+1)-th columns during the first horizontal period.

Each of the shared pixel groups in the i-th column of the pixel array 110 has a 1×2 shared pixel structure including a first pixel, i.e., an R pixel, and a second pixel, i.e., a Gb pixel, of the basic Bayer pattern. Each of the shared pixel groups in the (i+1)-th column of the pixel array 110 has a 1×2 shared pixel structure including a third pixel, i.e., a Gr pixel, and a fourth pixel, i.e., a B pixel, of the basic Bayer pattern. During a j-th horizontal period, pixel data output to the first and second readout lines LINE1 and LINE2 may be data of first (R) and second (Gb) pixels in shared pixel groups in k-th and (k+1)-th rows of the i-th column, and pixel data output to the third and fourth readout lines LINE3 and LINE4 may be data of third (Gr) and fourth (B) pixels in the k-th and (k+1)-th rows of the (i+1)-th column, where “j” and “k” are respectively 1 or a natural number greater than 1.

Pixel data output to the first through fourth readout lines LINE1 through LINE4 during a single horizontal period is R, Gb, Gr and B pixel data corresponding to the basic Bayer pattern. Pixels from which pixel data are read out in the i-th and (i+1)-th columns sequentially shift to adjacent next pixels from which the pixel data is output in a column direction at each horizontal period. For example, at a second horizontal period, pixel data is read out from pixels next to pixels from which the pixel data was output in a column direction at the previous (i.e., first) horizontal period. Moreover, at a third horizontal period, pixel data is read out from pixels next to pixels from which the pixel data was output in a column direction at the previous (i.e., second) horizontal period.

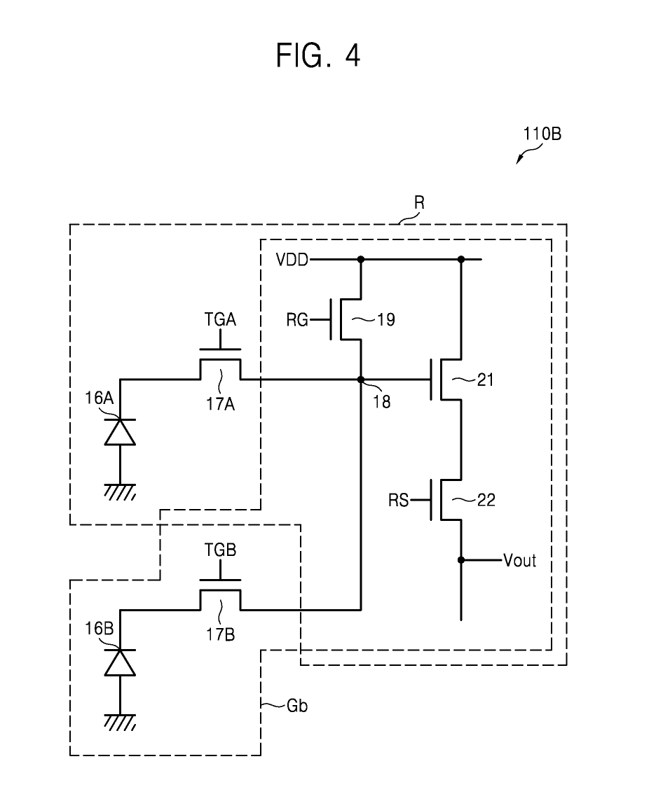

FIG. 4 is a circuit diagram of a 1×2 shared pixel structure 110B according to an exemplary embodiment. Referring to FIG. 4, an R pixel and a Gb pixel share elements with each other than photodiodes 16A and 16B and transfer transistors 17A and 17B. The transfer transistors 17A and 17B transfer charges generated at the photodiodes 16A and 16B to a floating diffusion node 18 in response to transfer signals TGA and TGB in the shared pixel structure 110B. That is, the R and Gb pixels share with each other the floating diffusion node 18, a reset transistor 19 resetting the floating diffusion node 18 to a power supply voltage VDD in response to a reset signal RG, a drive transistor 21, and a selection transistor 22 outputting pixel data Vout generated based on the operations of the photodiodes 16A and 16B in response to a selection signal RS output from the row driver 120.

Though a shared pixel structure is based on a pixel having 4-transistor (T) architecture in the above exemplary embodiment illustrated in FIG. 4, it is understood that another exemplary embodiment is not limited thereto.

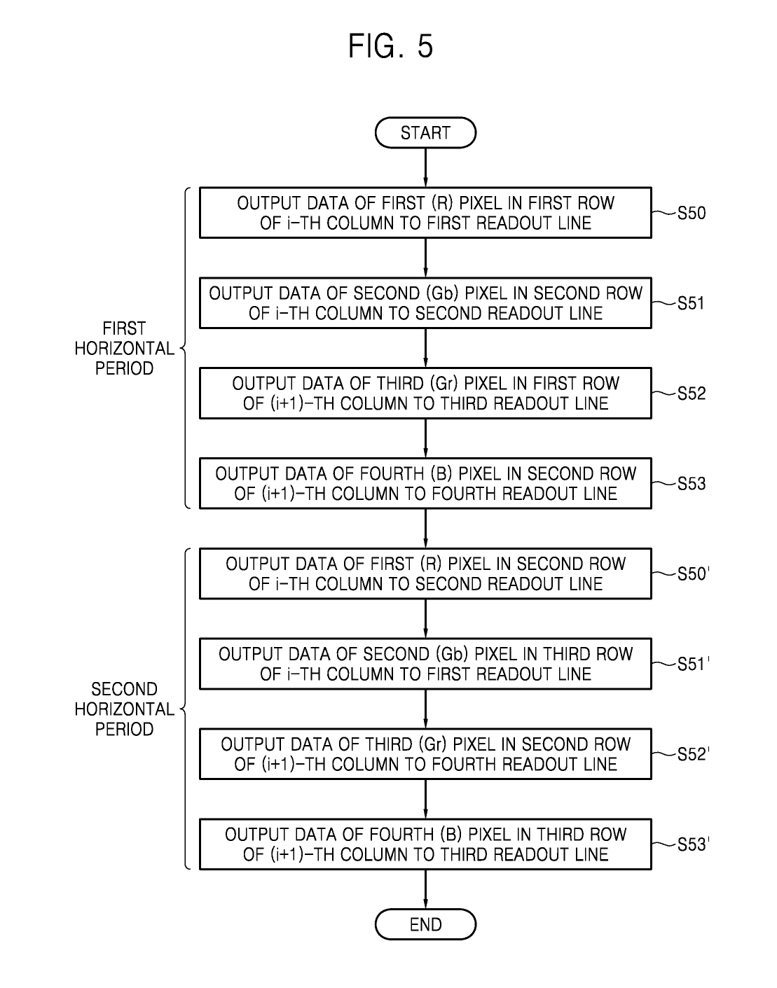

FIG. 5 is a flowchart of a procedure where data is read out from a pixel array 110 having a 1×2 shared pixel structure according to an exemplary embodiment. Referring to FIGS. 3 through 5, during a first horizontal period, data of the first (R) pixel in the first row ROW1 of the i-th column is output to the first readout line LINE1 in operation S50, data of the second (Gb) pixel in the second row ROW2 of the i-th column is output to the second readout line LINE2 in operation S51, data of the third (Gr) pixel in the first row ROW1 of the (i+1)-th column is output to the third readout line LINE3 in operation S52, and data of the fourth (B) pixel in the second row ROW2 of the (i+1)-th column is output to the fourth readout line LINE4 in operation S53.

During the second horizontal period, data of the first (R) pixel in the second row ROW2 of the i-th column is output to the second readout line LINE2 in operation S50′, data of the second (Gb) pixel in the third row ROW3 of the i-th column is output to the first readout line LINE1 in operation S51′, data of the third (Gr) pixel in the second row ROW2 of the (i+1)-th column is output to the fourth readout line LINE4 in operation S52′, and data of the fourth (B) pixel in the third row ROW3 of the (i+1)-th column is output to the third readout line LINE3 in operation S53′.

Accordingly, pixel data is output from pixels in two rows during a single horizontal period. Accordingly, the CMOS image sensor 100 including the pixel array 110 having the shared pixel structure illustrated in FIG. 3 has a higher frame rate than related art image sensors. In addition, pixel data output to the readout lines LINE1 through LINE4 during the first and second horizontal periods are R, Gb, Gr and B pixel data corresponding to a basic Bayer pattern. Accordingly, the CMOS image sensor 100 including the pixel array 110 having the shared pixel structure illustrated in FIG. 3 does not need a line memory for arranging pixel data output from the readout lines LINE1 through LINE4 in the Bayer pattern to construct an image from the pixel data output from the pixel array 110. Therefore, the CMOS image sensor 100 according to an exemplary embodiment is implemented in a smaller area than related art image sensors. Moreover, pixels from which pixel data is read out in the i-th and (i+1)-th columns sequentially shift to adjacent next pixels from which the pixel data is output in a column direction at each horizontal period.

While a pixel data readout operation on shared pixel groups in the adjacent i-th and (i+1)-th columns during the first and second horizontal periods has been described above, it is understood that a pixel data readout operation on a whole pixel array 110 can be performed when the operation is expanded in row and column directions.

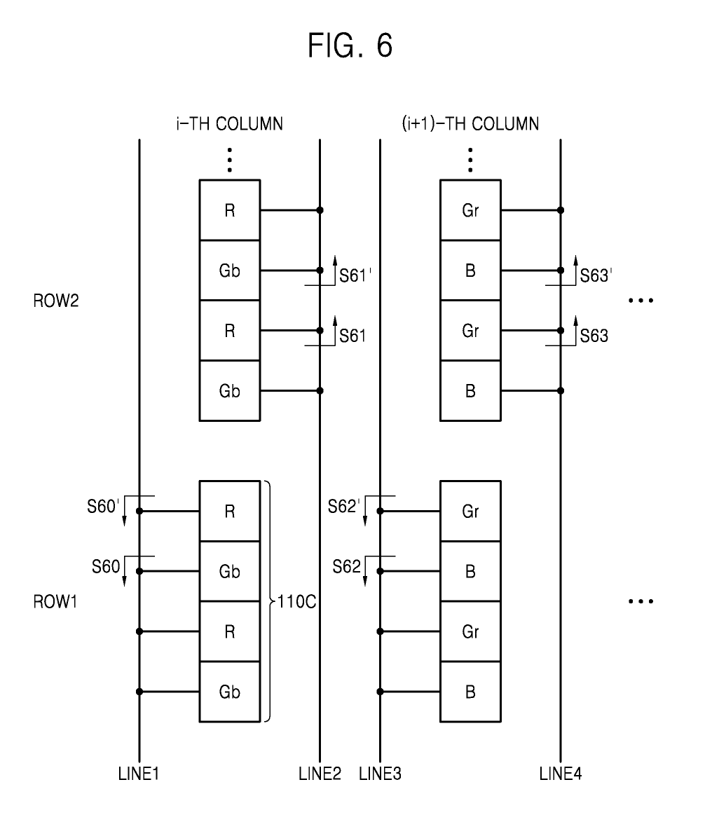

FIG. 6 is a diagram showing a procedure where data is read out from a pixel array 110 having a 1×4 shared pixel structure 110C according to an exemplary embodiment. In a shared pixel structure 110C illustrated in FIG. 6, like the shared pixel structure 110B illustrated in FIG. 4, four pixels share elements, such as a floating diffusion node and a reset transistor, other than four photodiodes and four transfer transistors.

Each of a plurality of shared pixel groups 110C in the i-th column of the pixel array 110 has a 1×4 shared pixel structure in which first (Gb) and second (R) pixels of the basic Bayer pattern repeatedly alternate with each other. Each of a plurality of shared pixel groups in the (i+1)-th column of the pixel array 110 has a 1×4 shared pixel structure in which third (B) and fourth (Gr) pixels of the basic Bayer pattern repeatedly alternate with each other.

During the j-th horizontal period, pixel data output to first and second readout lines LINE1 and LINE2 may be data of one of two first (Gb) pixels in a shared pixel group in the k-th row of the i-th column and data of one of two second (R) pixels in a shared pixel group in the (k+1)-th row of the i-th column, where “j” and “k” are respectively 1 or a natural number greater than 1. Also, during the j-th horizontal period, pixel data output to third and fourth readout lines LINE3 and LINE4 may be data of one of two third (B) pixels in a shared pixel group in the k-th row of the (i+1)-th column and data of one of two fourth (Gr) pixels in a shared pixel group in the (k+1)-th row of the (i+1)-th column.

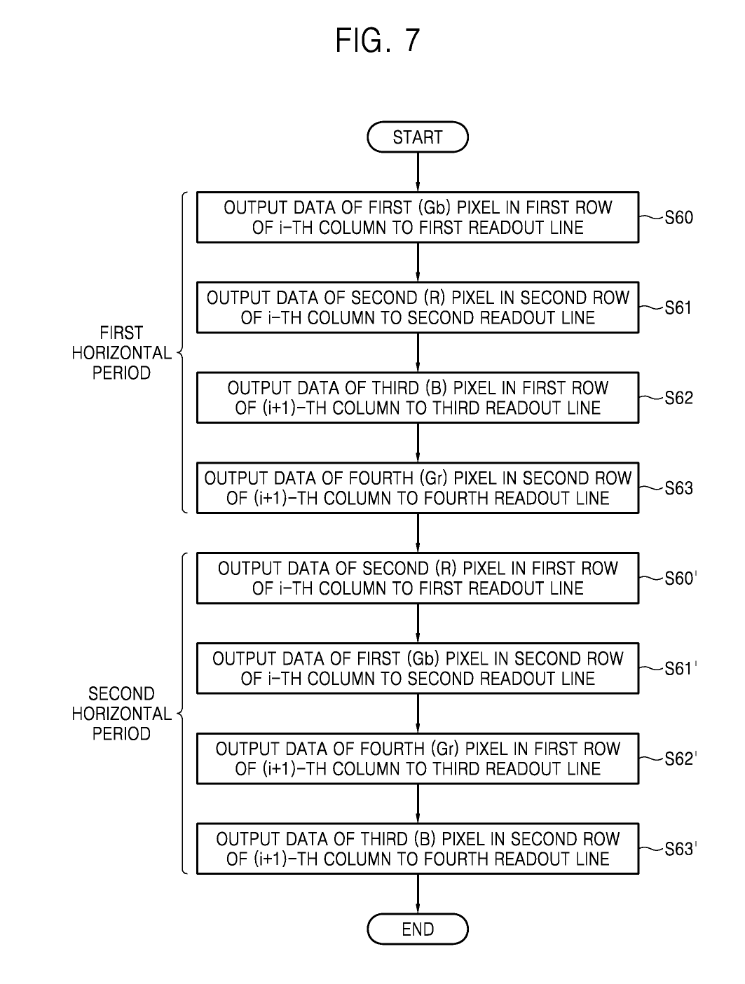

FIG. 7 is a flowchart of a procedure where data is read out from a pixel array 110 having a 1×4 shared pixel structure according to an exemplary embodiment. Referring to FIGS. 6 and 7, during a first horizontal period, data of a first (Gb) pixel in the first row ROW1 of the i-th column is output to the first readout line LINE1 in operation S60, data of a second (R) pixel in the second row ROW2 of the i-th column is output to the second readout line LINE2 in operation S61, data of a third (B) pixel in the first row ROW1 of the (i+1)-th column is output to the third readout line LINE3 in operation S62; and data of a fourth (Gr) pixel in the second row ROW2 of the (i+1)-th column is output to the fourth readout line LINE4 in operation S63.

During a second horizontal period, data of a second (B) pixel in the first row ROW1 of the i-th column is output to the first readout line LINE1 in operation S60′, data of a first (Gb) pixel in the second row ROW2 of the i-th column is output to the second readout line LINE2 in operation S61′, data of a fourth (Gr) pixel in the first row ROW1 of the (i+1)-th column is output to the third readout line LINE3 in operation S62′, and data of the third (B) pixel in the second row ROW2 of the (i+1)-th column is output to the fourth readout line LINE4 in operation S63′.

Like the pixel data readout method illustrated in FIGS. 3 and 5, the pixel data readout method illustrated in FIGS. 6 and 7 is also characterized by pixel data being output from pixels in two rows during a single horizontal period. Furthermore, pixel data output to the readout lines LINE1 through LINE4 during the first and second horizontal periods are Gb, R, B and Gr pixel data or R, Gb, Gr and B pixel data, which corresponds to the basic Bayer pattern, and pixels from which pixel data is read out in the i-th and (i+1)-th columns sequentially shift to adjacent next pixels from which the pixel data is output in a column direction at each horizontal period.

While a pixel data readout operation on shared pixel groups in the adjacent i-th and (i+1)-th columns during the first and second horizontal periods has been described above, it is understood that that a pixel data readout operation on a whole pixel array 110 can be performed when the operation is expanded in row and column directions.

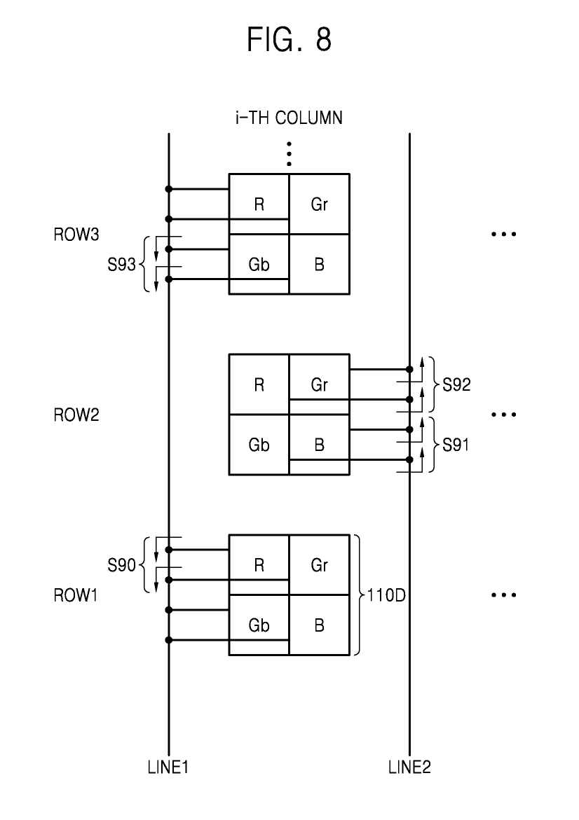

FIG. 8 is a diagram showing a procedure where data is read out from a pixel array 110 having a 2×2 shared pixel structure 110D according to an exemplary embodiment. In the shared pixel structure 110D illustrated in FIG. 8, like the shared pixel structure 110B illustrated in FIG. 4, an R pixel and a Gr pixel may share elements, such as a floating diffusion node and a reset transistor, other than two photodiodes and two transfer transistors. Furthermore, a Gb pixel and a B pixel may share elements, such as a floating diffusion node and a reset transistor, other than two photodiodes and two transfer transistors.

Unlike the pixel array 110 having the shared pixel structure illustrated in FIG. 3 or 6, the pixel array 110 having the pixel array structure illustrated in FIG. 8 outputs data of two pixels in one of two adjacent rows to a first readout line LINE1 and data of two pixels in another of the two adjacent rows to a second readout line LINE2 during each horizontal period. The first readout line LINE1 outputs pixel data from a shared pixel group in an odd row of each of the columns included in the pixel array 110 in the Bayer pattern during each horizontal period. The second readout line LINE2 outputs pixel data from a shared pixel group in an even row of each of the columns included in the pixel array 110 during each horizontal period.

Pixel data output to the first and second readout lines LINE1 and LINE2 during each horizontal period correspond to the basic Bayer pattern. Pixels from which pixel data are read out in each column sequentially shift to adjacent next pixels from which the pixel data is output in a column direction at each horizontal period. Each shared pixel group includes a first (R) pixel, a second (Gr) pixel, a third (B) pixel, and a fourth (Gb) pixel corresponding to the basic Bayer pattern.

During the j-th horizontal period, data of first and second pixels (i.e., R and Gr pixels) in a shared pixel group in the k-th row of each column is sequentially output through the first readout line LINE1, and data of third and fourth pixels (i.e., B and Gb pixels) in a shared pixel group in the (k+1)-th row of each column are sequentially output through the second readout line LINE2, where “j” and “k” are respectively 1 or a natural number greater than 1. However, to output pixel data in a basic Bayer pattern during a single horizontal period, a CMOS image sensor 100 skips Gb and B pixels in a first sub row of a shared pixel group in the first row ROW1 and outputs to the first readout line LINE1 pixel data of R and Gr pixels in a second sub row of the shared pixel group in the first row ROW1 during a first horizontal period.

Accordingly, during the first horizontal period, the pixel data of the R and Gr pixels in the second sub row of the shared pixel group in the first row ROW1 and pixel data of Gb and R pixels in a first sub row of a shared pixel group in the second row ROW2 are output. That is, R, Gr, Gb and B pixel data corresponding to the basic Bayer pattern are output through the first and second readout lines LINE1 and LINE2 from the first horizontal period.

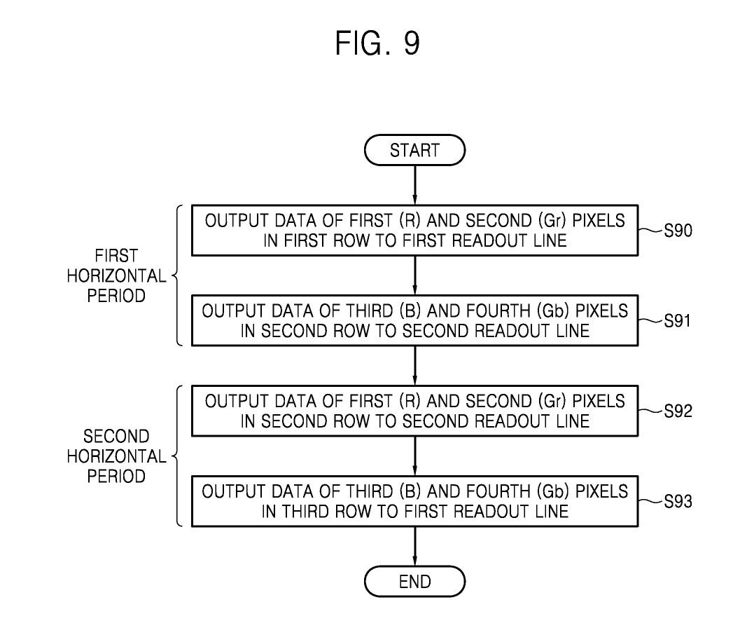

FIG. 9 is a flowchart of a procedure where data is read out from a pixel array 110 having a 2×2 shared pixel structure according to an exemplary embodiment. Referring to FIGS. 8 and 9, during the first horizontal period, data of a first (R) pixel and a second (Gr) pixel in the first row ROW1 are output to the first readout line LINE1 in operation S90 and data of a third (B) pixel and a fourth (GB) pixel in the second row ROW2 are output to the second readout line LINE2 in operation S91. During a second horizontal period, data of a first (R) pixel and a second (Gr) pixel in the second row ROW2 are output to the second readout line LINE2 in operation S92 and data of a third (B) pixel and a fourth (GB) pixel in the third row ROW3 are output to the first readout line LINE1 in operation S93.

According to the pixel data readout method illustrated in FIGS. 8 and 9, pixel data is output from pixels in two rows and data of two pixels are output from each of the two rows during a single horizontal period. Furthermore, pixel data output to the readout lines LINE1 and LINE2 during the first and second horizontal periods are R, Gr, B and Gb pixel data corresponding to the basic Bayer pattern, and pixels from which pixel data is read out in the i-th column sequentially shift to adjacent next pixels from which the pixel data is output in a column direction at each horizontal period, where “i” is 1 or a natural number greater than 1.

While a pixel data readout operation on a shared pixel group during the first and second horizontal periods has been described above, it is understood that a pixel data readout operation on a whole pixel array 110 can be performed when the operation is expanded in row and column directions.

All or some part of the CMOS image sensor 100 according to one or more exemplary embodiments may be packed in various types of packages. For example, the various packages may include Package on Package (PoP), Ball grid arrays (BGAs), Chip scale packages (CSPs), Plastic Leaded Chip Carrier (PLCC), Plastic Dual In-Line Package (PDIP), Die in Waffle Pack, Die in Wafer Form, Chip On Board (COB), Ceramic Dual In-Line Package (CERDIP), Plastic Metric Quad Flat Pack (MQFP), Thin Quad Flatpack (TQFP), Small Outline (SOIC), Shrink Small Outline Package (SSOP), Thin Small Outline (TSOP), Thin Quad Flatpack (TQFP), System In Package (SIP), Multi Chip Package (MCP), Wafer-level Fabricated Package (WFP), Wafer-Level Processed Stack Package (WSP), etc.

While not restricted thereto, an exemplary embodiment can also be embodied as computer-readable codes on a computer-readable medium. The computer-readable recording medium is any data storage device that can store data as a program which can be thereafter read by a computer system. Examples of the computer-readable recording medium include read-only memory (ROM), random-access memory (RAM), CD-ROMs, magnetic tapes, floppy disks, and optical data storage devices. Furthermore, an exemplary embodiment can also be embodied as computer-readable codes on a computer-readable transmission medium. The computer-readable transmission medium can transmit carrier waves or signals (e.g., wired or wireless data transmission through the Internet). The computer-readable recording medium can also be distributed over network coupled computer systems so that the computer-readable code is stored and executed in a distributed fashion. Also, functional programs, codes, and code segments to accomplish the present general inventive concept can be easily construed by programmers skilled in the art to which the present general inventive concept pertains.

In the above exemplary embodiments, two readout lines are connected to a single column in the pixel array 110 and the CMOS image sensor 100 reads out pixel data from shared pixel groups in two rows during a single horizontal period. However, it is understood that another exemplary embodiment is not restricted thereto.

According to another exemplary embodiment, a CMOS image sensor may include a plurality of first readout lines outputting pixel data from a plurality of shared pixel groups in an i-th column of a pixel array during each horizontal period and a plurality of second readout lines outputting pixel data from a plurality of shared pixel groups in an (i+1)-th column of the pixel array during the one horizontal period. That is, the image sensor may output pixel data from shared pixel groups in at least two rows during each horizontal period. At this time, pixel data output through the first readout lines, pixel data output through the second readout lines, and pixel data output through the first and second readout lines during a single horizontal period may correspond to at least one basic Bayer pattern. Moreover, pixels from which pixel data is read out in the i-th and (i+1)-th columns may sequentially shift to adjacent next pixels from which the pixel data is output in a column direction at each horizontal period.

A backside illumination image sensor (BIS) having a higher degree of freedom for metal routing than a front-side illumination image sensor (FIS) may facilitate implementation of a CMOS image sensor including a plurality of readout lines according to an exemplary embodiment.

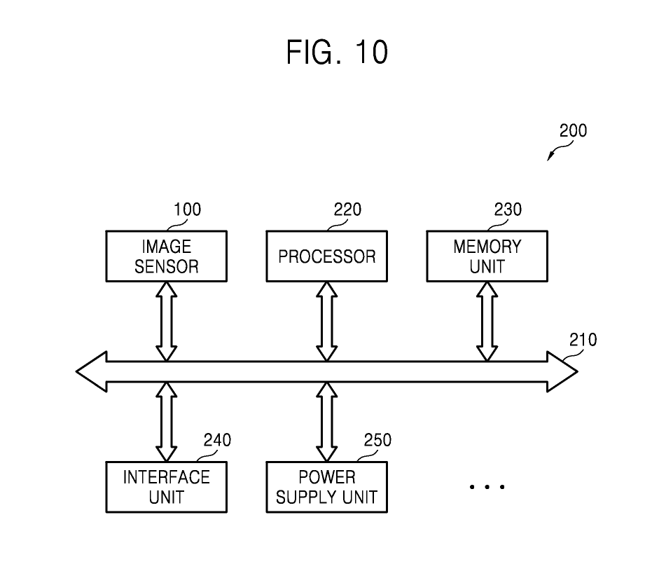

FIG. 10 is a block diagram of an electronic system 200 including a CMOS image sensor 100 according to an exemplary embodiment. Referring to FIG. 10, the electronic system 200 may include the CMOS image sensor 100, a processor 220, a memory unit 230, an interface unit 240, and a power supply unit 250, which are connected to a system bus 210. By way of example, the electronic system 200 may be a portable computer with a camera function, a digital camera, a personal digital assistant (PDA), a cellular telephone, etc., though it is understood that an exemplary embodiment is not restricted to these examples.

The CMOS image sensor 100 may generate and output an electrical image signal corresponding to a subject. An image generated by the CMOS image sensor 100 may be stored in the memory unit 230. The memory unit 230 may also store various application programs for operating the electronic system 200. Accordingly, the memory unit 230 may, although not necessarily, include a non-volatile memory such as a flash memory or a read-only memory (ROM) that retains stored data even when power supply to the electronic system 200 is interrupted.

The processor 220 may perform various computations used for the operation of the electronic system 200, including computations using pixel data output from the CMOS image sensor 100. Furthermore, the processor 220 may control an overall operation of the power supply unit 250. The memory unit 230 may temporarily store data used for the computations of the processor 220 or data generated from the computations. Accordingly, the memory unit 230 may, although not necessarily, include a volatile memory such as a random access memory (RAM) for storing data temporarily.

The interface unit 240 enables the electronic system 200 to communicate data with an external device or a network. The power supply unit 250 may include at least one of a battery to supply power to the electronic system 200 independently of an external power supply or a power supply circuit that supplies power received from an external power supply to the electronic system 200. Although not shown, the electronic system 200 may also include a display unit that provides users with images corresponding to various data including images stored in the memory unit 230.

As described above, according to one or more exemplary embodiments, a CMOS image sensor reads out data from pixels in a plurality of rows during a single horizontal period, thereby increasing a frame rate. In addition, the CMOS image sensor reads out data from pixels in a plurality of rows in units corresponding to a basic Bayer pattern and therefore does not need a separate memory for temporary storage, thereby reducing resource consumption.

While exemplary embodiments have been particularly shown and described with reference to the drawings, it will be understood by those of ordinary skill in the art that various changes in forms and details may be made therein without departing from the spirit and scope of the present inventive concept as defined by the following claims.

1. A complementary metal-oxide semiconductor (CMOS) image sensor comprising:
a first readout line which outputs pixel data from a shared pixel group in an odd row of an i-th column of a pixel array in a Bayer pattern during a horizontal period, where i is 1 or a natural number greater than 1;
a second readout line which outputs pixel data from a shared pixel group in an even row of the i-th column of the pixel array during the horizontal period;
a third readout line which outputs pixel data from a shared pixel group in an odd row of an (i+1)-th column of the pixel array during the horizontal period; and
a fourth readout line which outputs pixel data from a shared pixel group in an even row of the (i+1)-th column of the pixel array during the horizontal period,
wherein the pixel data output through the first through fourth readout lines during the horizontal period correspond to a basic Bayer pattern and pixels from which pixel data are read out in the i-th and (i+1)-th columns sequentially shift in a column direction at each horizontal period.

2. The CMOS image sensor of claim 1, wherein:
each of a plurality of shared pixel groups in the i-th column of the pixel array, including the shared pixel group in the odd mw of the i-th column and the shared pixel group in the even row of the i-th column, has a 1×2 shared pixel structure comprising a first pixel and a second pixel of the basic Bayer pattern; and
each of a plurality of shared pixel groups in the (i+1)-th column of the pixel array, including the shared pixel group in the odd row of the (i+1)-th column and the shared pixel group in the even row of the (i+1)-th column, has a 1×2 shared pixel structure comprising a third pixel and a fourth pixel of the basic Bayer pattern.

3. The CMOS image sensor of claim 2, wherein during a j-th horizontal period:
pixel data output to the first readout line is data of a first pixel in a shared pixel group in a k-th row of the i-th column;
pixel data output to the second readout line is data of a second pixel in a shared pixel group in a (k+1)-th row of the i-th column;
pixel data output to the third readout line is data of a third pixel in a shared pixel group in the k-th row of the (i+1)-th column;
pixel data output to the fourth readout line is data of a fourth pixel in a shared pixel group in the (k+1)-th row of the (i+1)-th column; and
j is 1 or a natural number greater than 1 and k is 1 or a natural number greater than 1.

4. The CMOS image sensor of claim 3, wherein:
pixel data output to the first readout line during a first horizontal period is from a pixel in a second sub row of a shared pixel group in a first row of the i-th column; and
pixel data output to the third readout line during the first horizontal period is from a pixel in a second sub row of a shared pixel group in the first row of the (i+1)-th column.

5. The CMOS image sensor of claim 1, wherein:
each of a plurality of shared pixel groups in the i-th column of the pixel array, including the shared pixel group in the odd mw of the i-th column and the shared pixel group in the even row of the i-th column, has a 1×4 shared pixel structure in which a first pixel and a second pixel of the basic Bayer pattern alternate with each other; and
each of a plurality of shared pixel groups in the (i+1)-th column of the pixel array, including the shared pixel group in the odd row of the (i+1)-th column and the shared pixel group in the even row of the (i+1)-th column, has a 1×4 shared pixel structure in which a third pixel and a fourth pixel of the basic Bayer pattern alternate with each other.

6. The CMOS image sensor of claim 5, wherein during a j-th horizontal period:
pixel data output to the first readout line is data of one of two first pixels in a shared pixel group in a k-th row of the i-th column;
pixel data output to the second readout line is data of one of two second pixels in a shared pixel group in a (k+1)-th row of the i-th column;
pixel data output to the third readout line is data of one of two third pixels in a shared pixel group in the k-th row of the (i+1)-th column;
pixel data output to the fourth readout line is data of one of two fourth pixels in a shared pixel group in the (k+1)-th row of the (i+1)-th column; and
j is 1 or a natural number greater than 1 and k is 1 or a natural number greater than 1.

7. An electronic system comprising:
the CMOS image sensor of claim 1; and
a processor which performs image signal processing on an electrical image signal output from the CMOS image sensor.

8. A complementary metal-oxide semiconductor (CMOS) image sensor comprising:
a first readout line which outputs pixel data from a shared pixel group in an odd mw of a column of a pixel array in a Bayer pattern during a horizontal period; and
a second readout line which outputs pixel data from a shared pixel group in an even row of the column of the pixel array during the horizontal period,
wherein pixel data output to the first and second readout lines during the horizontal period correspond to a basic Bayer pattern and pixels from which pixel data are read out in each column sequentially shifts in a column direction at each horizontal period.

9. The CMOS image sensor of claim 8, wherein each of a plurality of shared pixel groups in each column of the pixel array, including the shared pixel group in the odd row of the column and the shared pixel group in the even row of the column, has a 2×2 shared pixel structure comprising a first pixel, a second pixel, a third pixel, and a fourth pixel of the basic Bayer pattern.

10. The CMOS image sensor of claim 9, wherein during a j-th horizontal period:
data of first and second pixels in a shared pixel group in a k-th row of the column are sequentially output through the first readout line; and
data of third and fourth pixels in a shared pixel group in a (k+1)-th row of the column are sequentially output through the second readout line; and
j is 1 or a natural number greater than 1 and k is 1 or a natural number greater than 1.

11. The CMOS image sensor of claim 9, wherein pixel data in a second sub row of a shared pixel group in a first row is output to the first readout line during a first horizontal period.

12. A complementary metal-oxide semiconductor (CMOS) image sensor comprising:
a plurality of first readout lines which output pixel data from a plurality of shared pixel groups in an i-th column of a pixel array in a Bayer pattern during a horizontal period, where i is 1 or a natural number greater than 1; and
a plurality of second readout lines which output pixel data from a plurality of shared pixel groups in an (i+1)-th column of the pixel array during the horizontal period,
wherein pixel data output through the plurality of first and the plurality of second readout lines during each horizontal period correspond to at least one basic Bayer pattern and pixels from which pixel data are read out in the i-th and (i+1)-th columns sequentially shift in a column direction at each horizontal period.

13. An electronic system comprising:
the CMOS image sensor of claim 12; and
a processor which performs image signal processing on an electrical image signal output from the CMOS image sensor.

14. A pixel data readout method of a complementary metal-oxide semiconductor (CMOS) image sensor, the method comprising
outputting first pixel data from a shared pixel group in an odd row of an i-th column of a pixel array in a Bayer pattern during a horizontal period, where i is 1 or a natural number greater than 1;
outputting second pixel data from a shared pixel group in an even row of the i-th column of the pixel array during a the period;
outputting third pixel data from a shared pixel group in an odd row of an (i+1)-th column of the pixel array during the horizontal period;
outputting fourth pixel data from a shared pixel group in an even row of the (i+1)-th column of the pixel array during the horizontal period,
wherein the first through fourth pixel data output during the horizontal period correspond to a basic Bayer pattern and pixels from which pixel data are read out in the i-th and (i+1)-th columns sequentially shift in a column direction at each horizontal period.

15. The pixel data readout method of claim 14, wherein:
each of a plurality of shared pixel groups in the i-th column of the pixel array, including the shared pixel group in the odd mw of the i-th column and the shared pixel group in the even row of the i-th column, has a 1×2 shared pixel structure comprising a first pixel and a second pixel of the basic Bayer pattern; and
each of a plurality of shared pixel groups in the (i+1)-th column of the pixel array, including the shared pixel group in the odd row of the i-th column and the shared pixel group in the even row of the (i+1)-th column, has a 1×2 shared pixel structure comprising a third pixel and a fourth pixel of the basic Bayer pattern.

16. The pixel data readout method of claim 15, wherein during a j-th horizontal period:
the first pixel data is data of a first pixel in a shared pixel group in a k-th row of the i-th column;
the second pixel data is data of a second pixel in a shared pixel group in a (k+1)-th row of the i-th column;
the third pixel data is data of a third pixel in a shared pixel group in the k-th row of the (i+1)-th column;
the fourth pixel data is data of a fourth pixel in a shared pixel group in the (k+1)-th row of the (i+1)-th column; and
j is 1 or a natural number greater than 1 and k is 1 or a natural number greater than 1.

17. The pixel data readout method of claim 15, wherein:
the first pixel data output during a first horizontal period is from a pixel in a second sub row of a shared pixel group in a first row of the i-th column; and
the third pixel data output during the first horizontal period is from a pixel in a second sub row of a shared pixel group in the first row of the (i+1)-th column.

18. The pixel data readout method of claim 14, wherein:
each of a plurality of shared pixel groups in the i-th column of the pixel array, including the shared pixel group in the odd mw of the i-th column and the shared pixel group in the even row of the i-th column, has a 1×4 shared pixel structure in which a first pixel and a second pixel of the basic Bayer pattern alternate with each other; and
each of a plurality of shared pixel groups in the (i+1)-th column of the pixel array, including the shared pixel group in the odd row of the i-th column and the shared pixel group in the even row of the (i+1)-th column, has a 1×4 shared pixel structure in which a third pixel and a fourth pixel of the basic Bayer pattern alternate with each other.

19. The pixel data readout method of claim 18, wherein during a j-th horizontal period:
the first pixel data is data of one of two first pixels in a shared pixel group in a k-th row of the i-th column;
the second pixel data is data of one of two second pixels in a shared pixel group in a (k+1)-th row of the i-th column;
the third pixel data is data of one of two third pixels in a shared pixel group in the k-th row of the (i+1)-th column;
the fourth pixel data is data of one of two fourth pixels in a shared pixel group in the (k+1)-th row of the (i+1)-th column; and
j is 1 or a natural number greater than 1 and k is 1 or a natural number greater than 1.

20-29. (canceled)
